(19) United States
(12) Patent Application Publication
(10) Pub. No.: US 2026/0168626 A1
(43) Pub. Date: Jun. 18, 2026

(54) HYDROGEN SUPPLY SYSTEM

(71) Applicants: HYUNDAI MOTOR COMPANY, Seoul (KR); KIA CORPORATION, Seoul (KR); DOOWON HEAVY INDUSTRIAL CO., LTD., Sacheon-si (KR)

(72) Inventors: Yeon Ho Kim, Hwaseong-si (KR); Hoyoung Jeong, Hwaseong-si (KR); Jihye Park, Hwaseong-si (KR); Yong Seon Park, Pyeongtaek-si (KR); Yun Ki Kwon, Seoul (KR); Tea Jin Lee, Pyeongtaek-si (KR)

(73) Assignees: HYUNDAI MOTOR COMPANY, Seoul (KR); KIA CORPORATION, Seoul (KR); DOOWON HEAVY INDUSTRIAL CO., LTD., Sacheon-si (KR)

(21) Appl. No.: 19/230,511

(22) Filed: Jun. 6, 2025

(30) Foreign Application Priority Data
Dec. 16, 2024 (KR) 10-2024-0187013

(51) Int. Cl. F17C 13/04

(52) U.S. Cl. CPC F17C 13/04; F17C 2221/012; F17C 2227/0157; F17C 2227/03

(57) ABSTRACT

A hydrogen supply system includes a first refrigerant circuit including a first compressor, a first heat-exchanger, a first expansion valve, and a second heat-exchanger sequentially disposed on a first refrigerant line. The system further includes a second refrigerant circuit including a second compressor, a third heat-exchanger, a second expansion valve, and the second heat-exchanger sequentially disposed on a second refrigerant line. The system further includes a first coolant circuit including a first coolant line and a first front valve, a first hydrogen compression tank configured to store a metal and a metal hydride, and a first rear valve sequentially disposed on the first coolant line. The system further includes a second coolant circuit including a second front valve, a second hydrogen compression tank configured to store a metal and a metal hydride, and a second rear valve, sequentially disposed on a second coolant line.

### CROSS-REFERENCE TO RELATED APPLICATION

This application claims priority to and the benefit of Korean Patent Application No. 10-2024-0187013 filed with the Korean Intellectual Property Office on Dec. 16, 2024, the entire contents of which are incorporated herein by reference.

### TECHNICAL FIELD

The present disclosure relates to a hydrogen supply system, and more particularly, the present disclosure relates to a hydrogen supply system capable of storing and compressing hydrogen gas by using metal and metal hydride.

### BACKGROUND

Recently, with a continuously increased interest in energy efficiency and an environmental pollution problem, the development of an environmentally-friendly vehicle capable of substantially substituting for an internal combustion engine vehicle is required.

The environment-friendly vehicle is classified into an electric vehicle driven using a fuel cell or electricity as a power source and a hybrid vehicle driven using an engine and an electrical battery.

A hydrogen vehicle is equipped with a cartridge storing hydrogen gas and generates power required for driving the vehicle by combusting the hydrogen stored in the cartridge.

When the hydrogen gas is consumed while the hydrogen vehicle is driving, hydrogen gas must be refilled into the cartridge at a hydrogen charging station. Conventionally, electric compressors are used to charge hydrogen gas into the cartridge at hydrogen charging stations.

However, when charging hydrogen gas into the cartridge by using an electric compressor, there is a problem that a lot of electric energy is consumed and maintenance costs are increased.

The matters described in the description of the related art are intended to enhance the understanding of the background of the present disclosure and may include matters that are not already known to those having ordinary skill in the art to which the present technology belongs.

### SUMMARY

The present disclosure attempts to provide a hydrogen supply system capable of decreasing electrical energy consumption to decrease the maintenance cost.

A hydrogen supply system may include a first refrigerant circuit including a first compressor, a first heat-exchanger, a first expansion valve, and a second heat-exchanger sequentially disposed on a first refrigerant line along which a refrigerant circulates. The hydrogen supply system may further include a second refrigerant circuit including a second compressor, a third heat-exchanger, a second expansion valve, and the second heat-exchanger sequentially disposed on a second refrigerant line along which the refrigerant circulates. The hydrogen supply system may further include a first coolant circuit including a first coolant line along which the coolant having heat-exchanged with the refrigerant circulating the first refrigerant circuit through the first heat-exchanger circulates. The first coolant circuit may further include a first front valve, a first hydrogen compression tank configured to store a metal, and a first rear valve sequentially disposed on the first coolant line. The hydrogen supply system may further include a second coolant circuit including a second front valve, a second hydrogen compression tank configured to store a metal, and a second rear valve, sequentially disposed on a second coolant line along which the coolant having heat-exchanged with the refrigerant circulating the second refrigerant circuit through the third heat-exchanger circulates. The first front valve may selectively and may fluidically connect the first coolant line on an upstream side of the first hydrogen compression tank and the second coolant line on an upstream side of the second hydrogen compression tank. The first rear valve may selectively and may fluidically connect the first coolant line on a downstream side of the first hydrogen compression tank and the second coolant line on a downstream side of the second hydrogen compression tank. The second front valve may selectively and may fluidically connect the second coolant line on the upstream side of the second hydrogen compression tank and the first coolant line on the upstream side of the first hydrogen compression tank. The second rear valve may selectively and may fluidically connect the second coolant line on the downstream side of the second hydrogen compression tank and the first coolant line on the downstream side of the first hydrogen compression tank.

The metal hydride stored in the first hydrogen compression tank and the second hydrogen compression tank may store or compress hydrogen gas depending on a temperature change of the coolant circulating the first coolant line and the second coolant line.

The first hydrogen compression tank may include a first tank body accommodating the metal; a first coolant inlet line selectively and fluidically connected to the first coolant line; a first coolant discharge line selectively and fluidically connected to the first coolant line; a first hydrogen inlet line configured to supply a hydrogen gas to the tank body and on which a 1-1-th hydrogen valve is disposed; and a first hydrogen discharge line configured to discharge the hydrogen gas desorbed from the metal hydride and on which a 1-2-th hydrogen valve is disposed.

The second hydrogen compression tank may include a second tank body accommodating the metal; a second coolant inlet line selectively and fluidically connected to the second coolant line; a second coolant discharge line selectively and fluidically connected to the second coolant line; a second hydrogen inlet line configured to supply the hydrogen gas to the tank body and on which a 2-1-th hydrogen valve is disposed; and a second hydrogen discharge line configured to discharge the hydrogen gas desorbed from the metal hydride and on which a 2-2-th hydrogen valve is disposed.

Depending on operations of the first front valve, the first rear valve, the second front valve, the second rear valve, the 1-1-th hydrogen valve, the 1-2-th hydrogen valve, the 2-1-th hydrogen valve, and the 2-2-th hydrogen valve, the hydrogen supply system operates in one mode among a first mode for cooling the metal of the first hydrogen compression tank and heating the metal hydride of the second hydrogen compression tank; a second mode for adsorbing the hydrogen gas onto the metal in the first hydrogen compression tank and discharging the hydrogen gas compressed at the second hydrogen compression tank; a third mode for heating the metal hydride of the first hydrogen compression tank and adsorbing the hydrogen gas on the metal in the second hydrogen compression tank; and a fourth mode for discharging the hydrogen gas compressed at the first hydrogen compression tank and heating the metal hydride of the second hydrogen compression tank.

In the first mode, the first front valve may fluidically connect the first heat-exchanger and the first hydrogen compression tank and may block the first coolant line on the upstream side of the first hydrogen compression tank and the second coolant line on the upstream side of the second hydrogen compression tank. The first rear valve may fluidically connect the first hydrogen compression tank and the first heat-exchanger and may block the first coolant line on the downstream side of the first hydrogen compression tank and the second coolant line on the downstream side of the second hydrogen compression tank. The second front valve may fluidically connect the third heat-exchanger and the second hydrogen compression tank and may block the second coolant line on the upstream side of the second hydrogen compression tank and the first coolant line on the upstream side of the first hydrogen compression tank. The second rear valve may fluidically connect the second hydrogen compression tank and the third heat-exchanger and may block the second coolant line on the downstream side of the second hydrogen compression tank and the first coolant line on the downstream side of the first hydrogen compression tank. The 1-1-th hydrogen valve and the 1-2-th hydrogen valve may be blocked, and the 2-1-th hydrogen valve and the 2-2-th hydrogen valve may be blocked.

In the second mode, the first front valve may fluidically connect the first heat-exchanger and the first hydrogen compression tank and may block the first coolant line on the upstream side of the first hydrogen compression tank and the second coolant line on the upstream side of the second hydrogen compression tank. The first rear valve may fluidically connect the first hydrogen compression tank and the first heat-exchanger and may block the first coolant line on the downstream side of the first hydrogen compression tank and the second coolant line on the downstream side of the second hydrogen compression tank. The second front valve may fluidically connect the third heat-exchanger and the second hydrogen compression tank and may block the second coolant line on the upstream side of the second hydrogen compression tank and the first coolant line on the upstream side of the first hydrogen compression tank. The second rear valve may fluidically connect the second hydrogen compression tank and the third heat-exchanger and may block the second coolant line on the downstream side of the second hydrogen compression tank and the first coolant line on the downstream side of the first hydrogen compression tank. The 1-1-th hydrogen valve may be opened, the 1-2-th hydrogen valve may be blocked, the 2-1-th hydrogen valve may be blocked, and the 2-2-th hydrogen valve may be opened.

In the third mode, the first front valve may block the first coolant line between the first heat-exchanger and the first hydrogen compression tank and may fluidically connect the first coolant line on the upstream side of the first hydrogen compression tank and the second coolant line on the upstream side of the second hydrogen compression tank. The first rear valve may block the first coolant line between the first hydrogen compression tank and the first heat-exchanger and may fluidically connect the first coolant line on the downstream side of the first hydrogen compression tank and the second coolant line on the downstream side of the second hydrogen compression tank. The second front valve may block between the third heat-exchanger and the second hydrogen compression tank and may fluidically connect the second coolant line on the upstream side of the second hydrogen compression tank and the first coolant line on the upstream side of the first hydrogen compression tank. The second rear valve may block between the second hydrogen compression tank and the third heat-exchanger and may fluidically connect the second coolant line on the downstream side of the second hydrogen compression tank and the first coolant line on the downstream side of the first hydrogen compression tank. The 1-1-th hydrogen valve and the 1-2-th hydrogen valve may be blocked, and the 2-1-th hydrogen valve and the 2-2-th hydrogen valve may be blocked.

In the fourth mode, the first front valve may block between the first heat-exchanger and the first hydrogen compression tank and may fluidically connect the first coolant line on the upstream side of the first hydrogen compression tank and the second coolant line on the upstream side of the second hydrogen compression tank. The first rear valve may block between the first hydrogen compression tank and the first heat-exchanger and may fluidically connect the first coolant line on the downstream side of the first hydrogen compression tank and the second coolant line on the downstream side of the second hydrogen compression tank. The second front valve may block between the third heat-exchanger and the second hydrogen compression tank and may fluidically connect the second coolant line on the upstream side of the second hydrogen compression tank and the first coolant line on the upstream side of the first hydrogen compression tank. The second rear valve may block between the second hydrogen compression tank and the third heat-exchanger and may fluidically connect the second coolant line on the downstream side of the second hydrogen compression tank and the first coolant line on the downstream side of the first hydrogen compression tank. The 1-1-th hydrogen valve may be blocked, the 1-2-th hydrogen valve may be opened, the 2-1-th hydrogen valve may be opened, and the 2-2-th hydrogen valve may be blocked.

The hydrogen supply system may further include a first auxiliary coolant line having a first side selectively and fluidically connected to the first rear valve and a second side joining the first coolant line on an upstream side of the first heat-exchanger. The hydrogen supply system may further include a second auxiliary coolant line having a first side selectively and fluidically connected to the second rear valve and a second side joining the second coolant line on an upstream side of the third heat-exchanger. The hydrogen supply system may further include a fourth heat-exchanger configured to heat-exchange the coolant flowing through the first auxiliary coolant line and the second auxiliary coolant line with an ambient air.

Depending on operations of the first rear valve and the second rear valve based on a temperature of the coolant flowing through the first coolant line and a temperature of the coolant flowing through the second coolant line, each of the coolant flowing through the first coolant line and the second coolant line may be blocked from heat-exchanging with the ambient air through the fourth heat-exchanger; the coolant flowing through the first coolant line may be heat-exchanged with the ambient air through the fourth heat-exchanger; or the coolant flowing through the second coolant line may be heat-exchanged with the ambient air through the fourth heat-exchanger.

When the temperature of the coolant flowing through the first coolant line is higher than or equal to a first predetermined temperature, and the temperature of the coolant flowing through the second coolant line is lower than or equal to a second predetermined temperature, the first rear valve may block the first coolant line and the first auxiliary coolant line; and the second rear valve may block the second coolant line and the second auxiliary coolant line.

When the temperature of the coolant flowing through the first coolant line is lower than or equal to a first predetermined temperature, the first rear valve may fluidically connect the first coolant line and the first auxiliary coolant line; and the coolant flowing through the first coolant line and the first auxiliary coolant line may be heat-exchanged with the ambient air through the fourth heat-exchanger.

When the temperature of the coolant flowing through the second coolant line is higher than or equal to a second predetermined temperature, the second rear valve may fluidically connect the second coolant line and the second auxiliary coolant line; and the coolant flowing through the second coolant line and the second auxiliary coolant line may be heat-exchanged with the ambient air through the fourth heat-exchanger.

The first rear valve and the second rear valve may be 4-way valves.

The first front valve and the second front valve may be 3-way valves.

According to an embodiment, by storing and compressing the hydrogen gas depending on the temperature change of the metal and the metal hydride, the electrical energy consumption may be decreased, and the maintenance cost may be reduced.

In addition, by simultaneously controlling two hydrogen compression tanks through two refrigerant circuits and two coolant circuits, the efficiency of hydrogen supply by the hydrogen compression tank may be improved.

Other effects that may be obtained or are predicted by an embodiment are explicitly or implicitly described in a detailed description of the present disclosure. In other words, various effects that are predicted according to embodiments are described in the following detailed description.

### BRIEF DESCRIPTION OF THE DRAWINGS

These drawings are for reference in describing embodiments of the present disclosure, and the technical spirit of the present disclosure should not be construed as being limited to the accompanying drawings.

FIG. 1 is a schematic view showing a configuration of a hydrogen charging station to which a hydrogen supply system is applied according to an embodiment of the present disclosure.

FIG. 2 is a block diagram showing a configuration of a hydrogen supply system according to an embodiment of the present disclosure.

FIG. 3 is a schematic view showing a configuration of a hydrogen compression tank according to an embodiment of the present disclosure.

FIG. 4 is a drawing for explaining a first mode and a second mode of a hydrogen supply system according to an embodiment of the present disclosure.

FIG. 5 is a drawing for explaining a cooling mode of a hydrogen compression tank according to an embodiment of the present disclosure.

FIG. 6 is a drawing for explaining an adsorption mode of a hydrogen compression tank according to an embodiment of the present disclosure.

FIG. 7 is a drawing for explaining a heating mode of a hydrogen compression tank according to an embodiment of the present disclosure.

FIG. 8 is a drawing for explaining a discharge mode of a hydrogen compression tank according to an embodiment of the present disclosure.

FIG. 9 is a drawing for explaining a third mode and a fourth mode of a hydrogen supply system according to an embodiment of the present disclosure.

FIG. 10 is a drawing for explaining a fifth mode of a hydrogen supply system according to an embodiment of the present disclosure.

FIG. 11 is a drawing for explaining a sixth mode of a hydrogen supply system according to an embodiment of the present disclosure.

FIG. 12 is a drawing for explaining a seventh mode of a hydrogen supply system according to an embodiment of the present disclosure.

It should be understood that the above-referenced drawings are not necessarily to scale but present a somewhat simplified representation of various features illustrating the basic principles of the disclosure. The specific design features of the present disclosure, including, for example, specific dimensions, orientations, locations, and shapes, will be determined in part by the particular intended application and use environment.

### DETAILED DESCRIPTION

The terms used herein are for the purpose of describing particular embodiments only and are not intended to limit the present disclosure. As used herein, the singular forms are intended to include the plural forms as well, unless the context clearly indicates otherwise. It should be further understood that the terms, such as “comprises” and “comprising,” when used in the present disclosure, specify the presence of stated features, integers, steps, operations, elements, and/or components and do not preclude the presence or addition of one or more other features, integers, steps, operations, elements, components, and/or groups thereof. As used herein, the term “and/or” includes any one or all combinations of one or more related items.

The present disclosure is described more fully hereinafter with reference to the accompanying drawings, in which embodiments of the disclosure are illustrated. As those having ordinary skill in the art should realize, the described embodiments may be modified in various different ways, without departing from the spirit or scope of the present disclosure.

The drawings and description should be regarded as illustrative in nature and not restrictive, and like reference numerals designate like elements throughout the present disclosure.

In addition, the size and thickness of each configuration shown in the drawings are arbitrarily shown for understanding and ease of description, but the present disclosure is not limited thereto, and the thickness of layers, films, panels, regions, etc., are exaggerated for clarity.

The terms, such as “module” and “unit” for a constituent element, used for the present disclosure are given in consideration of only easiness of the writing of the present disclosure, and the terms themselves do not have a discriminated meaning or role. When a controller, module, unit, component, device, element, or the like of the present disclosure is described as having a purpose or performing an operation, function, or the like, the controller, module, unit, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

Further, in describing the embodiments disclosed in the present disclosure, when it is determined that detailed description relating to well-known functions or configurations may make the subject matter of the embodiments disclosed in the present disclosure unnecessarily ambiguous, the detailed description has been omitted.

Further, the accompanying drawings are provided for helping to easily understand embodiments disclosed in the present disclosure, and the technical spirit disclosed in the present disclosure is not limited by the accompanying drawings. It should be appreciated that the present disclosure includes all of the modifications, equivalent matters, and substitutes included in the spirit and the technical scope of the present disclosure.

Terms including ordinal numbers such as first, second, and the like are used only to describe various components and should not be interpreted as limiting these components.

As used herein, the singular forms, such as “a”, “an” and “the,” are intended to include the plural forms as well, unless the context clearly indicates otherwise.

The terms are only used to differentiate one component from others.

A hydrogen charging station to which a hydrogen supply system according to an embodiment is applied is described in detail below.

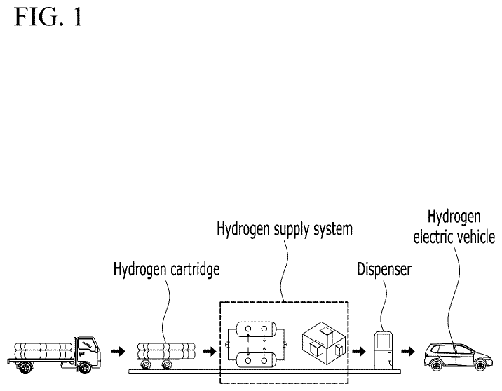

FIG. 1 is a schematic view showing a configuration of a hydrogen charging station to which a hydrogen supply system according to an embodiment is applied.

Referring to FIG. 1, a hydrogen charging station to which a hydrogen supply system according to an embodiment is applied is described in detail.

A hydrogen supply system according to an embodiment may be applied to a hydrogen charging station configured to charge a hydrogen gas.

A hydrogen supply system according to an embodiment may store or compress the hydrogen gas by utilizing the principle that hydrogen is adsorbed on or desorbed from the metal hydride (MH) depending on the temperature change of the metal hydride (MH).

For example, when a metal is cooled, hydrogen molecules may be adsorbed on the metal to be converted into the form of metal hydride, and accordingly, the hydrogen gas may be stored in a container containing the metal in the form of metal hydride. To the contrary, when the metal hydride is heated, hydrogen molecules adsorbed on the metal hydride may be desorbed, and the hydrogen gas may be compressed in a container containing the metal hydride.

By utilizing such a principle, a hydrogen supply system according to an embodiment may be applied to a hydrogen charging station. For example, when a hydrogen cartridge is loaded onto a tube trailer and enters a hydrogen charging station, the hydrogen charged inside hydrogen cartridge may be supplied to the hydrogen supply system and may cool the metal inside the hydrogen supply system so that the hydrogen may be stored in the form of metal hydride. Thereafter, when the metal hydride is heated so that hydrogen is desorbed from the metal hydride and the pressure increases, the hydrogen gas may be charged into the hydrogen electric vehicle, via a dispenser.

Hereinafter, a hydrogen supply system according to an embodiment is described in detail with reference to the drawings.

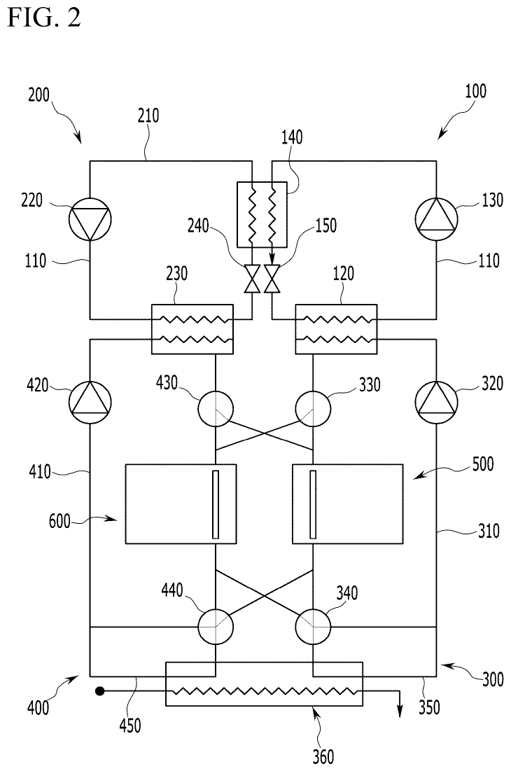

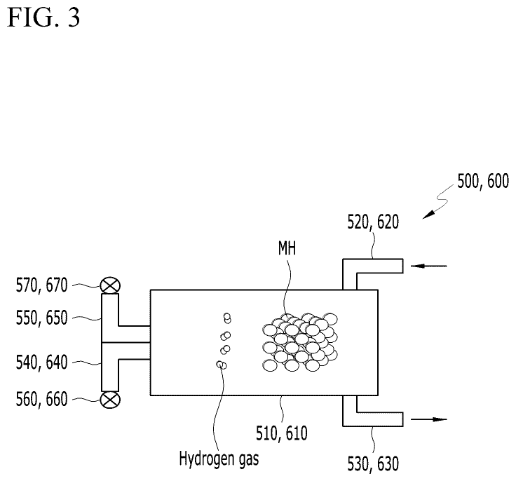

FIG. 2 is a block diagram showing a configuration of a hydrogen supply system according to an embodiment. In addition, FIG. 3 is a schematic view showing a configuration of a hydrogen compression tank according to an embodiment.

As shown in FIG. 2, a hydrogen supply system according to an embodiment may include a first refrigerant circuit 100 in which the refrigerant circulates, a second refrigerant circuit 200 in which the refrigerant circulates, a first coolant circuit 300 along which the coolant circulates, and a second coolant circuit 400 in which coolant circulates.

The first refrigerant circuit 100 may include a first refrigerant line 110 along which the refrigerant circulates. The first refrigerant circuit 100 may further include a first compressor 130, a first heat-exchanger 120, a first expansion valve 150, and a second heat-exchanger 140 sequentially disposed on the first refrigerant line 110. The first compressor 130, the first heat-exchanger 120, the first expansion valve 150, and the second heat-exchanger 140 may be sequentially disposed on the first refrigerant line 110 along the flow direction of the refrigerant.

The second refrigerant circuit 200 may include a second refrigerant line 210 along which the refrigerant circulates. The second refrigerant circuit 200 may further include a second compressor 220, a third heat-exchanger 230, a second expansion valve 240, and the second heat-exchanger 140 sequentially disposed on the second refrigerant line 210. The second compressor 220, the third heat-exchanger 230, the second expansion valve 240, and the second heat-exchanger 140 may be sequentially disposed on the second refrigerant line 210 along the flow direction of the refrigerant.

The first heat-exchanger 120 may be provided on the first refrigerant line 110 and the second refrigerant line 210, so that the cold refrigerant flowing through the first refrigerant line 110 and the hot refrigerant flowing through the second refrigerant line 210 may be heat-exchanged with each other through the first heat-exchanger 120.

The first coolant circuit 300 may include a first coolant line 310 along which the coolant having heat-exchanged with the refrigerant circulating the first refrigerant circuit 100 through the first heat-exchanger 120 flows. The first coolant circuit 300 may further include a first front valve 330, a first hydrogen compression tank 500, a first rear valve 340, and a first coolant pump 320, sequentially disposed on the first coolant line 310.

The first coolant circuit 300 may further include a first auxiliary coolant line 350 for selectively and fluidically connecting the first coolant line 310 on an upstream side of the first heat-exchanger 120 and the first front valve 330. A first side of the first auxiliary coolant line 350 may be selectively and fluidically connected to the first rear valve 340, and a second side of the first auxiliary coolant line 350 may be joined to the first coolant line 310 on the upstream side of the first heat-exchanger 120. A fourth heat-exchanger 360 may be disposed on the first auxiliary coolant line 350, and the coolant flowing along the first auxiliary coolant line 350 through the first coolant line 310 may be heat-exchanged with the ambient air through the fourth heat-exchanger 360.

Depending on an operation of the first front valve 330, the first coolant line 310 on an upstream side of the first hydrogen compression tank 500 and a second coolant line 410 on an upstream side of a second hydrogen compression tank 600 may be selectively and fluidically connected. For example, depending on the operation of the first front valve 330, it is possible that the first heat-exchanger 120 and the first hydrogen compression tank 500 are fluidically connected, and the first coolant line 310 and the second coolant line 410 are fluidically blocked. Alternatively, it is possible that the first heat-exchanger 120 and the first hydrogen compression tank 500 are fluidically blocked, and the first coolant line 310 on the upstream side of the first hydrogen compression tank 500 and the second coolant line 410 on the upstream side of the second hydrogen compression tank 600 are fluidically connected.

For such a purpose, the first front valve 330 may be implemented as a 3-way valve.

Depending on an operation of the first rear valve 340, the first coolant line 310 on a downstream side of the first hydrogen compression tank 500 and the second coolant line 410 on a downstream side of the second hydrogen compression tank 600 may be selectively and fluidically connected. For example, depending on the operation of the first rear valve 340, it is possible that the first coolant line 310 between the first heat-exchanger 120 and the first hydrogen compression tank 500 is fluidically connected and the first coolant line 310 on the downstream side of the first hydrogen compression tank 500 and the second coolant line 410 on the downstream side of the second hydrogen compression tank 600 are fluidically connected. Alternatively, it is possible that the first coolant line 310 between the first heat-exchanger 120 and the first hydrogen compression tank 500 is fluidically blocked and the first coolant line 310 on the downstream side of the first hydrogen compression tank 500 and the second coolant line 410 on the downstream side of the second hydrogen compression tank 600 are fluidically connected.

Additionally, the first rear valve 340 may selectively and fluidically connect the first coolant line 310 and the first auxiliary coolant line 350. For example, depending on the operation of the first rear valve 340, the first coolant line 310 and the first auxiliary coolant line 350 may be fluidically connected. Alternatively, the first coolant line 310 and the first auxiliary coolant line 350 may be fluidically blocked.

For such a purpose, the first rear valve 340 may be implemented as a 4-way valve.

The second coolant circuit 400 may include the second coolant line 410 along which the coolant having heat-exchanged with the refrigerant circulating the second refrigerant circuit 200 through the third heat-exchanger 230 flows. The second coolant circuit 400 may further include a second front valve 430, the second hydrogen compression tank 600, a second rear valve 440, and a second coolant pump 420, sequentially disposed on the second coolant line 410.

The second coolant circuit 400 may further include a second auxiliary coolant line 450 that selectively and fluidically connects the second coolant line 410 on an upstream side of the third heat-exchanger 230 and the second front valve 430. A first side of the second auxiliary coolant line 450 may be selectively and fluidically connected to the second rear valve 440, and a second side of the second auxiliary coolant line 450 may be joined to the second coolant line 410 on the upstream side of the third heat-exchanger 230. The fourth heat-exchanger 360 may be disposed on the second auxiliary coolant line 450, and the coolant flowing along the second auxiliary coolant line 450 through the second coolant line 410 may be heat-exchanged with the ambient air through the fourth heat-exchanger 360.

In an embodiment, the fourth heat-exchanger 360 may be disposed to share the first auxiliary coolant line 350 and the second auxiliary coolant line 450. If necessary, the fourth heat-exchanger 360 may be disposed on each of the first auxiliary coolant line 350 and the second auxiliary coolant line 450.

Depending on an operation of the second front valve 430, the second coolant line 410 on the upstream side of the second hydrogen compression tank 600, and the first coolant line 310 on the upstream side of the first hydrogen compression tank 500 may be selectively and fluidically connected. For example, depending on the operation of the second front valve 430, it is possible that the third heat-exchanger 230 and the second hydrogen compression tank 600 are fluidically connected, and the second coolant line 410 and the first coolant line 310 is fluidically blocked. Alternatively, it is possible that the third heat-exchanger 230 and the second hydrogen compression tank 600 are fluidically blocked, and the second coolant line 410 on the upstream side of the second hydrogen compression tank 600 and the first coolant line 310 on the upstream side of the first hydrogen compression tank 500 are fluidically connected.

For such a purpose, the second front valve 430 may be implemented as a 3-way valve.

Depending on an operation of the second rear valve 440, the second coolant line 410 on the downstream side of the second hydrogen compression tank 600 and the first coolant line 310 on the downstream side of the first hydrogen compression tank 500 may be selectively and fluidically connected. For example, depending on the operation of the second rear valve 440, it is possible that the first coolant line 310 between the third heat-exchanger 230 and the second hydrogen compression tank 600 are fluidically connected, and the second coolant line 410 on the downstream side of the second hydrogen compression tank 600 and the first coolant line 310 on the downstream side of the first hydrogen compression tank 500 are fluidically connected. Alternatively, it is possible that the second coolant line 410 between the third heat-exchanger 230 and the second hydrogen compression tank 600 are fluidically blocked, and the second coolant line 410 on the downstream side of the second hydrogen compression tank 600 and the first coolant line 310 on the downstream side of the first hydrogen compression tank 500 are fluidically connected.

Additionally, the second rear valve 440 may selectively and fluidically connect the second coolant line 410 and the second auxiliary coolant line 450. For example, depending on the operation of the second rear valve 440, the second coolant line 410 and the second auxiliary coolant line 450 may be fluidically connected. Alternatively, the second coolant line 410 and the second auxiliary coolant line 450 may be fluidically blocked.

For such a purpose, the first rear valve 340 may be implemented as a 4-way valve.

Depending on the operations of the first front valve 330, the first rear valve 340, the second front valve 430, and the second rear valve 440, the coolant circulating the first coolant line 310 and the coolant circulating the second coolant line 410 may be selectively supplied to the first hydrogen compression tank 500 and the second hydrogen compression tank 600.

For example, depending on the operations of the first front valve 330, the first rear valve 340, the second front valve 430, and the second rear valve 440, it is possible that the coolant flowing through the first coolant line 310 is supplied to the first hydrogen compression tank 500, and the coolant flowing through the second coolant line 410 is supplied to the second hydrogen compression tank 600. Alternatively, it is possible that the coolant flowing through the first coolant line 310 is supplied to the second hydrogen compression tank 600, and the coolant flowing through the second coolant line 410 is supplied to the first hydrogen compression tank 500.

The metal may be stored inside the first and second hydrogen compression tanks 600. The metal stored in the first and second hydrogen compression tanks 600 may store and compress the hydrogen gas depending on the temperature change of the coolant circulating the first and second coolant lines 410.

As described above, when a metal is cooled by a cold coolant, hydrogen molecules may be adsorbed on the metal, and accordingly, the hydrogen gas may be stored in the first and second hydrogen compression tanks 500, 600, in the form of metal hydride. To the contrary, when the metal hydride is heated by the high-temperature coolant, hydrogen molecules adsorbed on the metal hydride may be desorbed, and accordingly, the hydrogen gas may be compressed in the first and second hydrogen compression tanks 500, 600.

Referring to FIG. 3, the first hydrogen compression tank 500 may include a first tank body 510 for storing a metal, a first coolant inlet line 520 for introducing the coolant into the first tank body 510, a first coolant discharge line 530 for discharging the coolant received through the first coolant inlet line 520 and having circulated the first tank body 510, a first hydrogen inlet line 540 for supplying the hydrogen gas to the first tank body 510, and a first hydrogen discharge line 550 for discharging the hydrogen gas generated at the first tank body 510.

Like the first hydrogen compression tank 500, the second hydrogen compression tank 600 may include a second tank body 610 for storing a metal, a second coolant inlet line 620 for introducing the coolant into the second tank body 610, a second coolant discharge line 630 for discharging the coolant received through the second coolant inlet line 620 and having circulated the second tank body 610, a second hydrogen inlet line 640 for supplying the hydrogen gas to the second tank body 610, and a second hydrogen discharge line 650 for discharging the hydrogen gas generated at the second tank body 610.

The first coolant inlet line 520 of the first hydrogen compression tank 500 may be selectively and fluidically connected to the first coolant line 310 on the upstream side of the first hydrogen compression tank 500 and may selectively and fluidically connected to the second coolant line 410 on the upstream side of the second hydrogen compression tank 600.

The first coolant discharge line 530 of the first hydrogen compression tank 500 may be selectively and fluidically connected to the first coolant line 310 on the downstream side of the first hydrogen compression tank 500 and may selectively and fluidically connected to the second coolant line 410 on the upstream side of the second hydrogen compression tank 600.

The second coolant inlet line 620 of the second hydrogen compression tank 600 may be selectively and fluidically connected to the second coolant line 410 on the upstream side of the second hydrogen compression tank 600 and may selectively and fluidically connected to the first coolant line 310 on the upstream side of the first hydrogen compression tank 500.

The second coolant discharge line 630 of the second hydrogen compression tank 600 may be selectively and fluidically connected to the second coolant line 410 on the downstream side of the second hydrogen compression tank 600 and may selectively and fluidically connected to the first coolant line 310 on the upstream side of the first hydrogen compression tank 500.

A 1-1-th hydrogen valve 560 may be disposed on the first hydrogen inlet line 540. Depending on the opening and closing of the 1-1-th hydrogen valve 560, the hydrogen gas may be selectively supplied to the first tank body 510. When the 1-1-th hydrogen valve 560 is opened, the hydrogen gas may be introduced into the first tank body 510, and when the 1-1-th hydrogen valve 560 is blocked, the hydrogen gas is not introduced into the first tank body 510.

A 1-2-th hydrogen valve 570 may be disposed on the first hydrogen discharge line 550. Depending on the opening and closing of the 1-2-th hydrogen valve 570, the hydrogen gas generated at the first tank body 510 may be selectively discharged. When the 1-2-th hydrogen valve 570 is opened, the hydrogen gas generated inside the first tank body 510 may be discharged to the outside of the first tank body 510, and when the 1-2-th hydrogen valve 570 is blocked, the hydrogen gas generated inside the first tank body 510 is not discharged to the outside of the first tank body 510.

A 2-1-th hydrogen valve 660 may be disposed on the second hydrogen inlet line 640. Depending on the opening and closing of the 2-1-th hydrogen valve 660, the hydrogen gas may be selectively supplied to the second tank body 610. When the 2-1-th hydrogen valve 660 is opened, the hydrogen gas may be introduced into the second tank body 610, and when the 2-1-th hydrogen valve 660 is blocked, the hydrogen gas is not introduced into the second tank body 610.

A 2-2-th hydrogen valve 670 may be disposed on the second hydrogen discharge line 650. Depending on the opening and closing of the 2-2-th hydrogen valve 670, the hydrogen gas generated at the second tank body 610 may be selectively discharged. When the 2-2-th hydrogen valve 670 is opened, the hydrogen gas generated inside the second tank body 610 may be discharged to the outside of the second tank body 610, and when the 2-2-th hydrogen valve 670 is blocked, the hydrogen gas generated inside the second tank body 610 is not discharged to the outside of the second tank body 610.

As described above, the metal may be accommodated inside the tank bodies 510 and 610.

Depending on the operations of the first front valve, the first rear valve, the second front valve, and the second rear valve, the tank body may be cooled by the cold coolant, and when the hydrogen gas is supplied to the tank body through the hydrogen inlet line, hydrogen molecules may be adsorbed on the metal. Accordingly, the hydrogen gas may be stored inside the tank body in the form of metal hydride.

To the contrary, depending on the operations of the first front valve, the first rear valve, the second front valve, and the second rear valve, and when the tank body is heated by the high-temperature coolant, hydrogen molecules may be desorbed from the metal hydride, and the hydrogen gas may be compressed inside the tank body.

Referring back to FIG. 2, the first compressor 130 disposed in the first refrigerant circuit 100 may compress a gaseous refrigerant into a high-temperature and high-pressure gaseous refrigerant.

The first heat-exchanger 120 may perform a heat-exchange between the refrigerant circulating the first refrigerant line 110 and the refrigerant circulating the second refrigerant line 210, and the refrigerant compressed by the first compressor 130 may be condensed into a liquid state. In other words, the first heat-exchanger 120 may condense the refrigerant supplied from the first compressor 130 through the heat-exchange with the refrigerant supplied through the second refrigerant line 210. In this case, in the first refrigerant circuit 100, the first heat-exchanger 120 may perform the function of a condenser.

The first expansion valve 150 may expand the refrigerant condensed by the first heat-exchanger 120, and the pressure of the refrigerant is decreased from a high pressure to a low pressure.

The second heat-exchanger 140 may perform a heat-exchange between the refrigerant circulating the first refrigerant line 110 and the coolant circulating the first coolant line 310 and may vaporize the low-pressure refrigerant having passed through the first expansion valve 150. Accordingly, the refrigerant in the liquid state may be phase-changed to a gaseous refrigerant. In addition, when the coolant circulating the first refrigerant circuit 100 is heat-exchanged with the cold refrigerant at the second heat-exchanger 140, the temperature of the coolant is lowered. In this case, in the first refrigerant circuit 100, the second heat-exchanger 140 may perform the function of an evaporator.

In an embodiment, the first refrigerant circuit 100 may perform the function of a cooling apparatus for cooling the refrigerant flowing through the first coolant line 310.

The second compressor 220 disposed in the second refrigerant circuit 200 may compress a gaseous refrigerant into a high-temperature and high-pressure gaseous refrigerant.

The third heat-exchanger 230 may heat-exchange the coolant circulating the second coolant line 410 and the refrigerant circulating the first refrigerant line 110, and the refrigerant compressed by the second compressor 220 may be condensed into a liquid state in the third heat-exchanger 230. In addition, when the coolant circulating the second coolant line 410 is heat-exchanged with the high-temperature refrigerant at the third heat-exchanger 230, the temperature of the coolant is increased. In this case, in the second refrigerant circuit 200, the third heat-exchanger 230 may perform the function of a condenser.

The second expansion valve 240 may expand the refrigerant condensed by the third heat-exchanger 230, and the pressure of the refrigerant is decreased from a high pressure to a low pressure.

The first heat-exchanger 120 may perform a heat-exchange between the refrigerant circulating the second refrigerant line 210 and the refrigerant circulating the first refrigerant line 110 and may vaporize the low-pressure refrigerant having passed through the second expansion valve 240. In this case, in the second refrigerant circuit 200, the first heat-exchanger 120 may perform the function of an evaporator.

In an embodiment, the second refrigerant circuit 200 may perform the function of a heating device for heating the refrigerant flowing through the second coolant line 410.

Hereinafter, operation of a hydrogen supply system according to an embodiment is described in detail with reference to the drawings.

A hydrogen supply system according to an embodiment may operate in one mode among a first mode for cooling the metal of the first hydrogen compression tank 500 and heating the metal hydride of the second hydrogen compression tank 600, a second mode for adsorbing the hydrogen gas onto the metal in the first hydrogen compression tank 500 and discharging the hydrogen gas compressed at the second hydrogen compression tank 600, a third mode for heating the metal hydride of the first hydrogen compression tank 500 and adsorbing the hydrogen gas on the metal in the second hydrogen compression tank 600, and a fourth mode for discharging the hydrogen gas compressed at the first hydrogen compression tank 500 and heating the metal hydride of the second hydrogen compression tank 600, depending on the operations of the first front valve 330, the first rear valve 340, the second front valve 430, the second rear valve 440, the 1-1-th hydrogen valve 560, 1-2-th hydrogen valve, 2-1-th hydrogen valve, and the 2-2-th hydrogen valve 670.

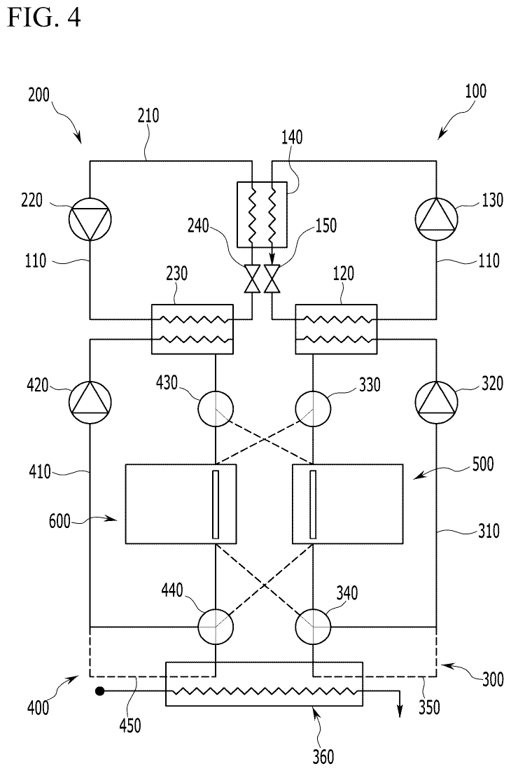

The first mode and the second mode is described in detail with reference to FIG. 4-FIG. 8.

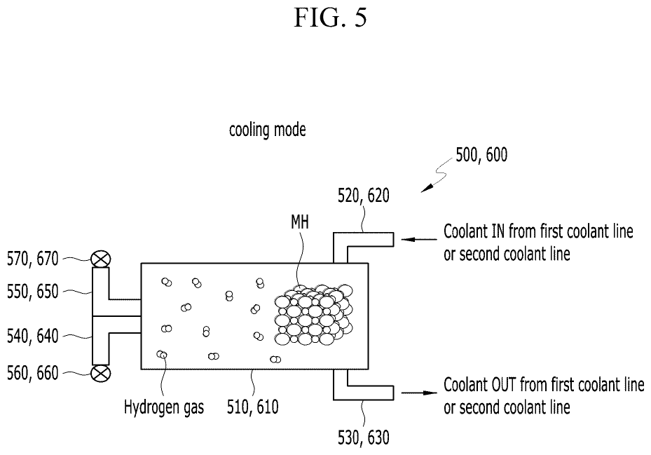

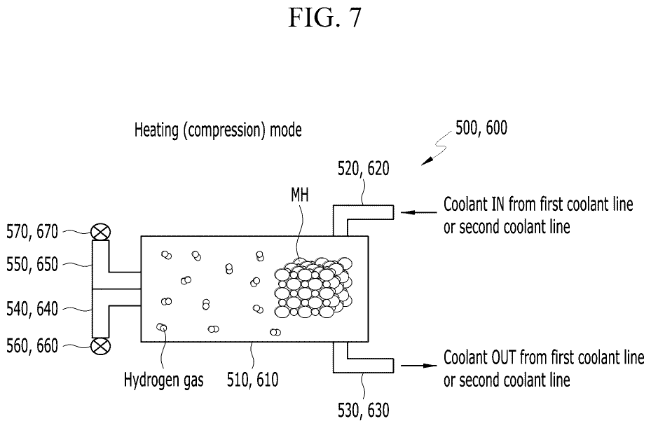

Referring to FIG. 4, FIG. 5 and FIG. 7, the first mode may be a mode for cooling the metal stored inside the first hydrogen compression tank 500 and heating the metal hydride stored inside the second hydrogen compression tank 600.

In the first mode, the first front valve 330 may fluidically connect the first coolant line 310 between the first heat-exchanger 120 and the first hydrogen compression tank 500 and may block the first coolant line 310 on the upstream side of the first hydrogen compression tank 500 and the second coolant line 410 on the upstream side of the second hydrogen compression tank 600.

The first rear valve 340 may fluidically connect the first coolant line 310 between the first hydrogen compression tank 500 and the first heat-exchanger 120 and may block the first coolant line 310 on the downstream side of the first hydrogen compression tank 500 and the second coolant line 410 on the downstream side of the second hydrogen compression tank 600.

The second front valve 430 may fluidically connect the second coolant line 410 between the third heat-exchanger 230 and the second hydrogen compression tank 600 and may fluidically connect the second coolant line 410 on the upstream side of the second hydrogen compression tank 600 and the first coolant line 310 on the upstream side of the first hydrogen compression tank 500.

The second rear valve 440 may fluidically connect the second coolant line 410 between the second hydrogen compression tank 600 and the third heat-exchanger 230 and may block the second coolant line 410 on the downstream side of the second hydrogen compression tank 600 and the first coolant line 310 on the downstream side of the first hydrogen compression tank 500.

In addition, the 1-1-th hydrogen valve 560 and the 1-2-th hydrogen valve 570 may be blocked (see FIG. 5), and the 2-1-th hydrogen valve 660 and the 2-2-th hydrogen valve 670 may be blocked (see FIG. 7).

Accordingly, the cold refrigerant circulating the first refrigerant circuit 100 and the coolant circulating the first coolant circuit 300 may be heat-exchanged in the first heat-exchanger 120, so that the temperature of the coolant circulating the first coolant circuit 300 is lowered.

The cooled coolant circulating the first coolant circuit 300 may cool the first hydrogen compression tank 500 through the first coolant line 310 and a 1-1-th coolant inlet line, and the metal stored inside the first tank body 510 may be cooled. As the 1-1-th hydrogen valve 560 and the 1-2-th hydrogen valve 570 are blocked, the hydrogen gas is not introduced into the first hydrogen compression tank 500 (see FIG. 5).

In addition, the high-temperature refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant circulating the second coolant circuit 400 may heat the second hydrogen compression tank 600 through the second coolant line 410 and a 2-1-th coolant inlet line, and the metal hydride stored inside the second tank body 610 may be heated. When the metal hydride is heated, hydrogen molecules may be desorbed from the metal hydride. Because the 2-1-th hydrogen valve 660 and the 2-2-th hydrogen valve 670 are blocked, the pressure of the hydrogen gas desorbed from the metal hydride inside the second hydrogen compression tank 600 may gradually increase (see FIG. 7).

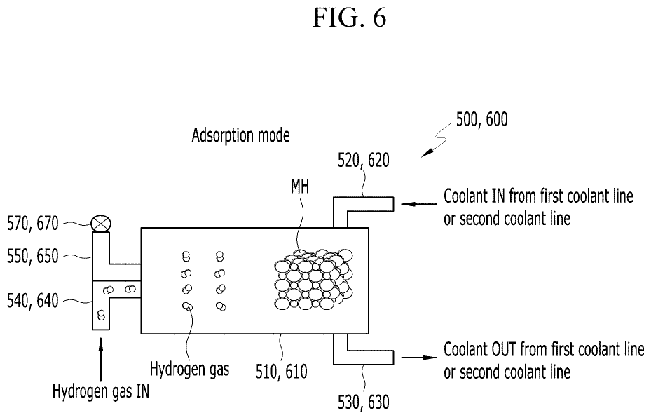

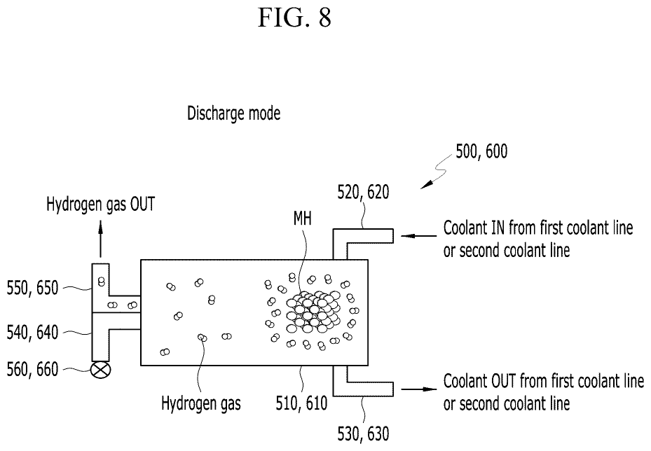

Referring to FIG. 4, FIG. 6, and FIG. 8, the second mode may be a mode in which the hydrogen gas is adsorbed and stored onto the metal inside the first hydrogen compression tank 500 and the hydrogen gas compressed inside the second hydrogen compression tank 600 is discharged.

The operations of the first front valve 330, the first rear valve 340, the second front valve 430 and the second rear valve 440 in the second mode are the same as the first mode. However, the 1-1-th hydrogen valve 560 may be opened, and the 1-2-th hydrogen valve 570 may be blocked, and the 2-1-th hydrogen valve 660 may be blocked, and the 2-2-th hydrogen valve 670 may be opened.

Accordingly, the cold refrigerant circulating the first refrigerant circuit 100 and the coolant circulating the first coolant circuit 300 may be heat-exchanged in the first heat-exchanger 120, so that the temperature of the coolant circulating the first coolant circuit 300 is lowered.

The cooled coolant circulating the first coolant circuit 300 may cool the first hydrogen compression tank 500 through the first coolant line 310 and the 1-1-th coolant inlet line, and the metal stored inside the first tank body 510 may be cooled.

As the 1-1-th hydrogen valve 560 is opened and the 1-2-th hydrogen valve 570 is blocked, the hydrogen gas may be introduced into the first tank body 510 through the first hydrogen inlet line 540. In addition, the hydrogen gas introduced into the first tank body 510 may be adsorbed on the cooled metal, and the hydrogen gas may be stored inside the first tank body 510 by being adsorbed (see FIG. 6).

In addition, the high-temperature refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant circulating the second coolant line 410 may heat the second hydrogen compression tank 600 through the second coolant line 410 and the 2-1-th coolant inlet line, and the metal hydride stored inside the second tank body 610 may be heated. When the metal hydride is heated, hydrogen molecules may be desorbed from the metal hydride.

As the 2-1-th hydrogen valve 660 is blocked and the 2-2-th hydrogen valve 670 is opened, the hydrogen gas compressed inside the second hydrogen compression tank 600 may be discharged to the outside through the second hydrogen discharge line 650 (see FIG. 8).

The third mode and the fourth mode are described in detail with reference to FIG. 5-FIG. 7 and FIG. 9.

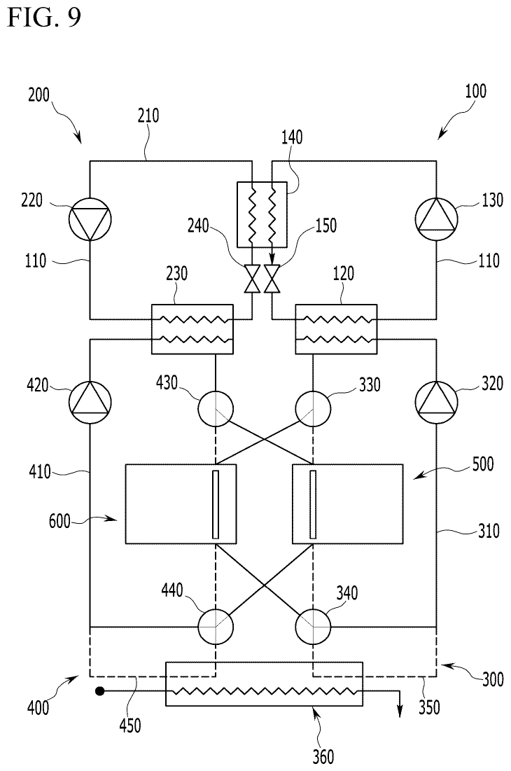

Referring to FIG. 9, FIG. 5, and FIG. 7, the third mode may be a mode for heating the metal hydride stored inside the first hydrogen compression tank 500 and cooling the metal stored inside the second hydrogen compression tank 600.

In the third mode, the first front valve 330 may block the first coolant line 310 between the first heat-exchanger 120 and the first hydrogen compression tank 500 and may fluidically connect the first coolant line 310 on the upstream side of the first hydrogen compression tank 500 and the second coolant line 410 on the upstream side of the second hydrogen compression tank 600.

The first rear valve 340 may block the first coolant line 310 between the first hydrogen compression tank 500 and the third heat-exchanger 230 and may fluidically connect the first coolant line 310 on the downstream side of the first hydrogen compression tank 500 and the second coolant line 410 on the downstream side of the second hydrogen compression tank 600.

The second front valve 430 may block the second coolant line 410 between the third heat-exchanger 230 and the second hydrogen compression tank 600 and may fluidically connect the second coolant line 410 on the downstream side of the second hydrogen compression tank 600 and the first coolant line 310 on the downstream side of the first hydrogen compression tank 500.

The second rear valve 440 may block the second coolant line 410 between the second hydrogen compression tank 600 and the third heat-exchanger 230 and may fluidically connect the second coolant line 410 on the downstream side of the second hydrogen compression tank 600 and the first coolant line 310 on the downstream side of the first hydrogen compression tank 500.

In addition, the 1-1-th hydrogen valve 560 and the 1-2-th hydrogen valve 570 may be blocked, and the 2-1-th hydrogen valve 660 and the 2-2-th hydrogen valve 670 may be blocked.

Accordingly, the cold refrigerant circulating the first refrigerant circuit 100 and the coolant circulating the first coolant circuit 300 may be heat-exchanged in the first heat-exchanger 120, so that the temperature of the coolant circulating the first coolant circuit 300 is lowered.

The cooled coolant circulating the first coolant circuit 300 may cool the second hydrogen compression tank 600 through the first coolant line 310, the second coolant line 410, and the 2-1-th coolant inlet line, and the metal stored inside the second tank body 610 may be cooled. Because the 2-1-th hydrogen valve 660 and the 2-2-th hydrogen valve 670 are blocked, the hydrogen gas is not introduced into the second hydrogen compression tank 600 (see FIG. 5).

In addition, the high-temperature refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant circulating the second coolant circuit 400 may heat the first hydrogen compression tank 500 through the second coolant line 410, the first coolant line 310, and the 1-1-th coolant inlet line, and the metal hydride stored inside the first tank body 510 may be heated. When the metal hydride is heated, hydrogen molecules may be desorbed from the metal hydride.

Because the 1-1-th hydrogen valve 560 and the 1-2-th hydrogen valve 570 are blocked, the pressure of the hydrogen gas desorbed from the metal hydride inside the first hydrogen compression tank 500 may gradually increase (see FIG. 7).

Referring to FIG. 9, FIG. 6, and FIG. 8, the fourth mode may be a mode in which the hydrogen gas compressed inside the first hydrogen compression tank 500 is discharged, and the hydrogen gas is adsorbed and stored onto the metal inside the second hydrogen compression tank 600.

The operations of the first front valve 330, the first rear valve 340, the second front valve 430 and the second rear valve 440 in the fourth mode are the same as the third mode. However, the 1-1-th hydrogen valve 560 may be blocked, and the 1-2-th hydrogen valve 570 may be opened, and the 2-1-th hydrogen valve 660 may be opened, and the 2-2-th hydrogen valve 670 may be blocked.

Accordingly, the cold refrigerant circulating the first refrigerant circuit 100 and the refrigerant circulating the first coolant circuit 300 may be heat-exchanged in the first heat-exchanger 120, so that the temperature of the coolant circulating the first coolant circuit 300 is lowered.

The cooled coolant circulating the first coolant circuit 300 may cool the second hydrogen compression tank 600 through the first coolant line 310, the second coolant line 410, and the 2-1-th coolant inlet line, and the metal stored inside the second tank body 610 may be cooled.

As the 2-1-th hydrogen valve 660 is opened and the 2-2-th hydrogen valve 670 is blocked, the hydrogen gas may be introduced into the second tank body 610 through the second hydrogen inlet line 640. In addition, the hydrogen gas introduced into the second tank body 610 may be adsorbed on the cooled metal, and the hydrogen gas may be stored in the second tank body 610 by being adsorbed (see FIG. 6).

In addition, the high-temperature refrigerant circulating the second refrigerant circuit 200 and the coolant circulating the second coolant circuit 400 may be heat-exchanged in the third heat-exchanger 230, so that the temperature of the coolant circulating the second coolant circuit 400 is increased.

The heated coolant flowing along the second coolant line 410 may heat the first hydrogen compression tank 500 through the second coolant line 410, the first coolant line 310, and the 1-1-th coolant inlet line, and the metal hydride stored inside the first tank body 510 may be heated. When the metal hydride is heated, hydrogen molecules may be desorbed from the metal hydride.

As the 1-1-th hydrogen valve 560 is blocked, and the 1-2-th hydrogen valve 570 is opened, the hydrogen gas compressed inside the first hydrogen compression tank 500 may be discharged to the outside through the first hydrogen discharge line 550 (see FIG. 8).

A hydrogen supply system according to an embodiment may absorb the external heat through the fourth heat-exchanger 360 or may discharge an unnecessary heat to the outside. For example, when the coolant circulating the first coolant line 310 is subcooled, the coolant flowing through the first coolant line 310 and the ambient air may be heat-exchanged through the fourth heat-exchanger 360, and the temperature of the coolant flowing through the first coolant line 310 may be increased. Accordingly, the coolant flowing through the first coolant line 310 may be prevented from being subcooled.

When the coolant circulating the second coolant line 410 is overheated, the coolant flowing through the second coolant line 410 and the ambient air may be heat-exchanged through the fourth heat-exchanger 360, and the temperature of the coolant flowing through the second coolant line 410 may be lowered. Accordingly, the coolant flowing through the second coolant line 410 may be prevented from being overheated.

In an embodiment, depending on the operations of the first rear valve 340 and the second rear valve 440 based on the coolant flowing through the first coolant line 310 temperature and the coolant flowing through the second coolant line 410 temperature, each of the coolant flowing through the first coolant line 310 and the second coolant line 410 may be blocked from heat-exchanging with the ambient air through the fourth heat-exchanger 360, the coolant flowing through the first coolant line 310 may be heat-exchanged with the ambient air through the fourth heat-exchanger 360, or the coolant flowing through the second coolant line 410 may be heat-exchanged with the ambient air through the fourth heat-exchanger 360.

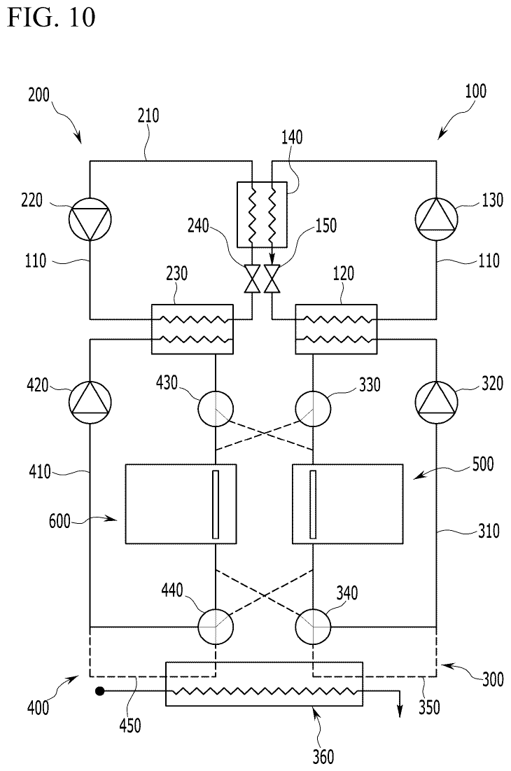

Referring to FIG. 10, while the coolant flowing through the first coolant line 310 and the temperature of the coolant flowing through the second coolant line 410 are normal (e.g., while the temperature of the coolant flowing along the first coolant line is higher than or equal to a first predetermined temperature, and the temperature of the coolant flowing along the second coolant line is lower than or equal to a second predetermined temperature), the first rear valve 340 may block the first coolant line 310 and the first auxiliary coolant line 350, and the second rear valve 440 may block the second coolant line 410 and the second auxiliary coolant line 450.

Accordingly, the coolant flowing through the first coolant line 310 and the coolant flowing through the second coolant line 410 is not heat-exchanged through the fourth heat-exchanger 360.

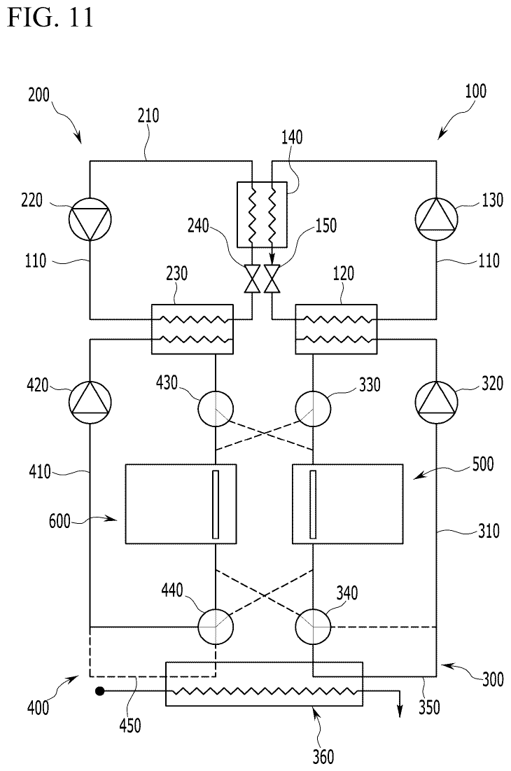

Referring to FIG. 11, in a subcooled state in which the temperature of the coolant flowing through the first coolant line 310 is lower than or equal to the predetermined temperature, the first rear valve 340 may fluidically connect the first coolant line 310 and the first coolant line 310. Accordingly, the coolant flowing through the first coolant line 310 and the first auxiliary coolant line 350 may be heat-exchanged with the ambient air through the fourth heat-exchanger 360. Accordingly, the temperature of the coolant flowing through the first coolant line 310 may be increased, so that the coolant flowing through the first coolant line 310 may be prevented from being subcooled.

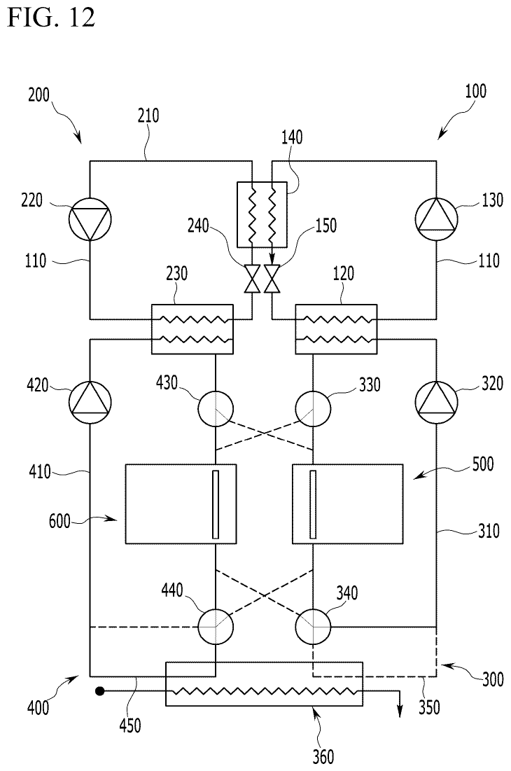

Referring to FIG. 12, in an overheated state in which the temperature of the coolant flowing through the second coolant line 410 is higher than or equal to the predetermined temperature, the second rear valve 440 may fluidically connect the second coolant line 410 and the second coolant line 410. Accordingly, the coolant flowing through the second coolant line 410 and the second auxiliary coolant line 450 may be heat-exchanged with the ambient air through the fourth heat-exchanger 360. Accordingly, the temperature of the coolant flowing through the second coolant line 410 may be lowered, so that the coolant flowing through the second coolant line 410 may be prevented from being overheated.

According to a hydrogen supply system according to an embodiment, by storing and compressing the hydrogen gas depending on the temperature change of the metal and the metal hydride, the consumption of electrical energy may be minimized, and the maintenance cost may be reduced.

In addition, by simultaneously controlling two hydrogen compression tanks through two refrigerant circuits and two coolant circuits, the efficiency of hydrogen supply by the hydrogen compression tank may be improved.

Although the embodiments of the present disclosure have been described, the present disclosure is not limited thereto. It is possible to carry out various modifications within the scope of the claims, the detailed description of the disclosure, and the accompanying drawings. The modifications belong to the scope of the present disclosure.

### DESCRIPTION OF SYMBOLS

100: first refrigerant circuit
110: first refrigerant line
120: first heat-exchanger
130: first compressor
140: second heat-exchanger
150: first expansion valve
200: second refrigerant circuit
210: second refrigerant line
220: second compressor
230: third heat-exchanger
240: second expansion valve
300: first coolant circuit
310: first coolant line
320: first coolant pump
330: first front valve
340: first rear valve
350: first auxiliary coolant line
360: fourth heat-exchanger
400: second coolant circuit
410: second coolant line
420: second coolant pump
430: second front valve
440: second rear valve
450: second auxiliary coolant line
500: first hydrogen compression tank
510: first tank body
520: first coolant inlet line
530: first coolant discharge line
540: first hydrogen inlet line
550: first hydrogen discharge line
560: 1-1-th hydrogen valve
570: 1-2-th hydrogen valve
600: second hydrogen compression tank
610: second tank body
620: second coolant inlet line
630: second coolant discharge line
640: second hydrogen inlet line
650: second hydrogen discharge line
660: second-1-th hydrogen valve
670: 2-2-th hydrogen valve

What is claimed is:

1. A hydrogen supply system, comprising:
a first refrigerant circuit comprising:
a first compressor, a first heat-exchanger, a first expansion valve, and a second heat-exchanger sequentially disposed on a first refrigerant line along which a refrigerant circulates;
a second refrigerant circuit comprising:
a second compressor, a third heat-exchanger, a second expansion valve, and the second heat-exchanger sequentially disposed on a second refrigerant line along which the refrigerant circulates;
a first coolant circuit comprising:
a first coolant line along which coolant having heat-exchanged with the refrigerant circulating the first refrigerant circuit through the first heat-exchanger circulates; and
a first front valve, a first hydrogen compression tank configured to store a metal and a metal hydride, and a first rear valve sequentially disposed on the first coolant line; and
a second coolant circuit comprising:
a second front valve, a second hydrogen compression tank configured to store a metal and a metal hydride, and a second rear valve sequentially disposed on a second coolant line along which the coolant having heat-exchanged with the refrigerant circulating the second refrigerant circuit through the third heat-exchanger circulates.

2. The hydrogen supply system of claim 1, wherein the first front valve is selectively and fluidically configured to connect the first coolant line on an upstream side of the first hydrogen compression tank and the second coolant line on an upstream side of the second hydrogen compression tank,
wherein the first rear valve is configured to selectively and fluidically connect the first coolant line on a downstream side of the first hydrogen compression tank and the second coolant line on a downstream side of the second hydrogen compression tank,
wherein the second front valve is configured to selectively and fluidically connect the second coolant line on the upstream side of the second hydrogen compression tank and the first coolant line on the upstream side of the first hydrogen compression tank, and
wherein the second rear valve is configured to selectively and fluidically connect the second coolant line on the downstream side of the second hydrogen compression tank and the first coolant line on the downstream side of the first hydrogen compression tank.

3. The hydrogen supply system of claim 1, wherein the metal hydride stored in the first hydrogen compression tank and the second hydrogen compression tank stores or compresses hydrogen gas depending on a temperature change of the coolant circulating the first coolant line and the second coolant line.

4. The hydrogen supply system of claim 2, wherein the first hydrogen compression tank comprises:
a first tank body configured to accommodate the metal and the metal hydride;
a first coolant inlet line selectively and fluidically connected to the first coolant line;
a first coolant discharge line selectively and fluidically connected to the first coolant line;
a first hydrogen inlet line configured to supply a hydrogen gas to the first tank body and on which a 1-1-th hydrogen valve is disposed; and
a first hydrogen discharge line configured to discharge the hydrogen gas desorbed from the metal hydride and on which a 1-2-th hydrogen valve is disposed.

5. The hydrogen supply system of claim 4, wherein the second hydrogen compression tank comprises:
a second tank body configured to accommodate the metal and the metal hydride;
a second coolant inlet line selectively and fluidically connected to the second coolant line;
a second coolant discharge line selectively and fluidically connected to the second coolant line;
a second hydrogen inlet line configured to supply the hydrogen gas to the second tank body and on which a 2-1-th hydrogen valve is disposed; and
a second hydrogen discharge line configured to discharge the hydrogen gas desorbed from the metal hydride and on which a 2-2-th hydrogen valve is disposed.

6. The hydrogen supply system of claim 5, wherein, depending on operations of the first front valve, the first rear valve, the second front valve, the second rear valve, the 1-1-th hydrogen valve, the 1-2-th hydrogen valve, the 2-1-th hydrogen valve, and the 2-2-th hydrogen valve, the hydrogen supply system operates in one mode among:
a first mode for cooling the metal of the first hydrogen compression tank and heating the metal hydride of the second hydrogen compression tank;
a second mode for adsorbing the hydrogen gas onto the metal in the first hydrogen compression tank and discharging the hydrogen gas compressed at the second hydrogen compression tank;
a third mode for heating the metal hydride of the first hydrogen compression tank and adsorbing the hydrogen gas on the metal in the second hydrogen compression tank; and
a fourth mode for discharging the hydrogen gas compressed at the first hydrogen compression tank and heating the metal hydride of the second hydrogen compression tank.

7. The hydrogen supply system of claim 6, wherein, in the first mode:
the first front valve is configured to:
fluidically connect the first heat-exchanger and the first hydrogen compression tank; and
block the first coolant line on the upstream side of the first hydrogen compression tank and the second coolant line on the upstream side of the second hydrogen compression tank;
the first rear valve is configured to:
fluidically connect the first hydrogen compression tank and the first heat-exchanger; and
block the first coolant line on the downstream side of the first hydrogen compression tank and the second coolant line on the downstream side of the second hydrogen compression tank;
the second front valve is configured to:
fluidically connect the third heat-exchanger and the second hydrogen compression tank; and
block the second coolant line on the upstream side of the second hydrogen compression tank and the first coolant line on the upstream side of the first hydrogen compression tank;
the second rear valve is configured to:
fluidically connect the second hydrogen compression tank and the third heat-exchanger; and
block the second coolant line on the downstream side of the second hydrogen compression tank and the first coolant line on the downstream side of the first hydrogen compression tank;
the 1-1-th hydrogen valve and the 1-2-th hydrogen valve are blocked; and
the 2-1-th hydrogen valve and the 2-2-th hydrogen valve are blocked.

8. The hydrogen supply system of claim 6, wherein, in the second mode:
the first front valve is configured to:
fluidically connect the first heat-exchanger and the first hydrogen compression tank; and
block the first coolant line on the upstream side of the first hydrogen compression tank and the second coolant line on the upstream side of the second hydrogen compression tank;
the first rear valve is configured to:
fluidically connect the first hydrogen compression tank and the first heat-exchanger; and
block the first coolant line on the downstream side of the first hydrogen compression tank and the second coolant line on the downstream side of the second hydrogen compression tank;
the second front valve is configured to:
fluidically connect the third heat-exchanger and the second hydrogen compression tank; and
block the second coolant line on the upstream side of the second hydrogen compression tank and the first coolant line on the upstream side of the first hydrogen compression tank;
the second rear valve is configured to:
fluidically connect the second hydrogen compression tank and the third heat-exchanger; and
block the second coolant line on the downstream side of the second hydrogen compression tank and the first coolant line on the downstream side of the first hydrogen compression tank;
the 1-1-th hydrogen valve is opened;
the 1-2-th hydrogen valve is blocked;
the 2-1-th hydrogen valve is blocked; and
the 2-2-th hydrogen valve is opened.

9. The hydrogen supply system of claim 6, wherein, in the third mode:
the first front valve is configured to:
block the first coolant line between the first heat-exchanger and the first hydrogen compression tank; and
fluidically connect the first coolant line on the upstream side of the first hydrogen compression tank and the second coolant line on the upstream side of the second hydrogen compression tank;
the first rear valve is configured to:
block the first coolant line between the first hydrogen compression tank and the first heat-exchanger; and
fluidically connect the first coolant line on the downstream side of the first hydrogen compression tank and the second coolant line on the downstream side of the second hydrogen compression tank;
the second front valve is configured to:
block between the third heat-exchanger and the second hydrogen compression tank; and
fluidically connect the second coolant line on the upstream side of the second hydrogen compression tank and the first coolant line on the upstream side of the first hydrogen compression tank;
the second rear valve is configured to:
block between the second hydrogen compression tank and the third heat-exchanger; and
fluidically connect the second coolant line on the downstream side of the second hydrogen compression tank and the first coolant line on the downstream side of the first hydrogen compression tank;
the 1-1-th hydrogen valve and the 1-2-th hydrogen valve are blocked; and
the 2-1-th hydrogen valve and the 2-2-th hydrogen valve are blocked.

10. The hydrogen supply system of claim 6, wherein, in the fourth mode:
the first front valve is configured to:
block between the first heat-exchanger and the first hydrogen compression tank; and
fluidically connect the first coolant line on the upstream side of the first hydrogen compression tank and the second coolant line on the upstream side of the second hydrogen compression tank;
the first rear valve is configured to:
block between the first hydrogen compression tank and the first heat-exchanger; and
fluidically connect the first coolant line on the downstream side of the first hydrogen compression tank and the second coolant line on the downstream side of the second hydrogen compression tank;
the second front valve is configured to:
block between the third heat-exchanger and the second hydrogen compression tank; and
fluidically connect the second coolant line on the upstream side of the second hydrogen compression tank and the first coolant line on the upstream side of the first hydrogen compression tank;
the second rear valve is configured to:
block between the second hydrogen compression tank and the third heat-exchanger; and
fluidically connect the second coolant line on the downstream side of the second hydrogen compression tank and the first coolant line on the downstream side of the first hydrogen compression tank;
the 1-1-th hydrogen valve is blocked;
the 1-2-th hydrogen valve is opened;
the 2-1-th hydrogen valve is opened; and
the 2-2-th hydrogen valve is blocked.

11. The hydrogen supply system of claim 6, further comprising:
a first auxiliary coolant line comprising:
a first side selectively and fluidically connected to the first rear valve; and
a second side joining the first coolant line on an upstream side of the first heat-exchanger;
a second auxiliary coolant line comprising:
a first side selectively and fluidically connected to the second rear valve; and
a second side joining the second coolant line on an upstream side of the third heat-exchanger; and
a fourth heat-exchanger configured to heat-exchange the coolant flowing through the first auxiliary coolant line and the second auxiliary coolant line with an ambient air.

12. The hydrogen supply system of claim 11, wherein, depending on operations of the first rear valve and the second rear valve based on a temperature of the coolant flowing through the first coolant line and a temperature of the coolant flowing through the second coolant line:
each of the coolant flowing through the first coolant line and the second coolant line is blocked from heat-exchanging with the ambient air through the fourth heat-exchanger;
the coolant flowing through the first coolant line is heat-exchanged with the ambient air through the fourth heat-exchanger; or
the coolant flowing through the second coolant line is heat-exchanged with the ambient air through the fourth heat-exchanger.

13. The hydrogen supply system of claim 12, wherein, when the temperature of the coolant flowing through the first coolant line is higher than or equal to a first predetermined temperature, and the temperature of the coolant flowing through the second coolant line is lower than or equal to a second predetermined temperature:
the first rear valve is configured to block the first coolant line and the first auxiliary coolant line; and
the second rear valve is configured to block the second coolant line and the second auxiliary coolant line.

14. The hydrogen supply system of claim 12, wherein, when the temperature of the coolant flowing through the first coolant line is lower than or equal to a first predetermined temperature:
the first rear valve is configured to fluidically connect the first coolant line and the first auxiliary coolant line; and
the coolant flowing through the first coolant line and the first auxiliary coolant line is heat-exchanged with the ambient air through the fourth heat-exchanger.

15. The hydrogen supply system of claim 12, wherein, when the temperature of the coolant flowing through the second coolant line is higher than or equal to a second predetermined temperature:
the second rear valve is configured to fluidically connect the second coolant line and the second auxiliary coolant line; and
the coolant flowing through the second coolant line and the second auxiliary coolant line is heat-exchanged with the ambient air through the fourth heat-exchanger.

16. The hydrogen supply system of claim 12, wherein the first rear valve and the second rear valve are 4-way valves.

17. The hydrogen supply system of claim 1, wherein the first front valve and the second front valve are 3-way valves.
